(19) United States
(12) Patent Application Publication
(10) Pub. No.: US 2018/0038687 A1
(43) Pub. Date: Feb. 8, 2018

(54) MEASUREMENT EQUIPMENT WITH OUTLIER FILTER

(71) Applicant: Worcester Plytechnic Institute, Worcester, MA (US)

(72) Inventors: Christopher A. Brown, Cazenovia, NY (US); Storie Nivers, Rosharon, TX (US); Matthew A. Gleason, Londonderry, NH (US); David Etievant, Chaux des Crotenay (FR); Tomasz Bartkowiak, Bydgoszcz (PL)

(21) Appl. No.: 15/670,533

(22) Filed: Aug. 7, 2017

Related U.S. Application Data
(60) Provisional application No. 62/371,360, filed on Aug. 5, 2016.

(51) Int. Cl. G01B 11/30; G01B 11/24; G01B 11/255; G06F 17/18

(52) U.S. Cl. CPC G01B 11/306; G06F 17/18; G01B 11/2441; G01B 11/255; G01B 11/2408; G01Q 60/24

(57) ABSTRACT

A surface topography analysis invokes a sensor device for receiving a series of values from a sensor element of measurement equipment adapted to quantify an input stimuli into a surface height value, and computes consecutive curvatures from the received series of values. An aggregate value (sum) of the consecutive curvatures is compared to a threshold, and based on the comparison, the approach concludes that at least one of the consecutive curvatures corresponds to an outlier. The set of values are based on a signal that is continuous, although not necessarily differentiable, as received from the measurement equipment. Such measurement equipment embodying the sensor device may further comprise at least one of atomic probe microscopes, interferometric microscopes, confocal microscopes, scanning laser microscopes, profiling instruments, scanners, and CMMs.

### RELATED APPLICATIONS:

This application claims the benefit under 35 U.S.C. § 119(e) of U.S. Provisional Patent Application No. 62/371,360, filed Aug. 5, 2016, entitled “MEASUREMENT EQUIPMENT WITH OUTLIER FILTER,” incorporated herein by reference in entirety.

### BACKGROUND

Statistics and related mathematical processing often involves sampling of a large number of values for identifying various characteristics, trends and anomalies. Conventional statistical operations, such as means and variance, may operate on sets of data that include outliers, often defined as spurious measurements, illegitimate data or doubtful observations. Such outliers can disproportionally skew output and detract from, rather than contribute to, overall accuracy of a set of values, compromising subsequent analysis.

### SUMMARY

A data collection system, method and apparatus for detecting and filtering invalid or erroneous values that tend to skew results generates a more reliable and accurate data stream or set. Statistical anomalies can have a substantial detrimental effect if the magnitude of the questionable value is greater than the true values. Gathered data, whether collected from sensors, manual entry, electrical stimuli or other collection mechanism, may contain inaccuracies. These spurious values, whether referred to as false, erroneous, inaccurate or invalid, can have a detrimental effect on results gleaned from the data. Conventional approaches often employ standard deviations or other arbitrary value as an absolute range. Beyond which values are discarded. This can result in both false positives and false negatives, where legitimate data is discarded and invalid values persist. Configurations herein, in contrast, group values by applying a curvature analysis to a stream of data values, and take successive derivatives of curvature until a grouping or pattern emerges. The disclosed approach is superior to an arbitrary setting or value because plateaus of values, such as a group or cluster of legitimate values well beyond an arithmetic mean, can be validated as legitimate while inaccuracies of a lesser magnitude may be dismissed. This contrasts with conventional approaches employing standard deviations, which would discard all values beyond a particular threshold without an inquiry as to validity.

A particular arrangement includes a filter for removing outliers (i.e., spurious measurements, illegitimate data or doubtful observations, from a continuous, although not necessarily differentiable, data stream, based on thresholds in the curvature, i.e., change in slope. The filtering approach then employs higher derivatives or finite differences, which, may be calculated at different scales or sampling intervals, primarily for topographic profiles and surfaces, although it could also be applied to data in a plurality of dimensions, with any units. A desirable, although not necessary, outcome is to have a bi-modal distribution at some scale and derivative so that the outliers form a distinct group to assist in their identification. As shown by the configurations herein, outliers tend to emerge from taking successive derivatives of the line or function defining the curvature until a bimodal distribution emerges.

Configurations herein are based, in part, on the observation that statistical processing and computations may encounter outliers, or deviant values that affect an output or interpretation in a disproportionate magnitude. Unfortunately, conventional approaches to handing outliers, outlying values or “doubtful” observations in a statistical set, suffer from the shortcoming that the considered outlier values are merely diminished, rather than eliminated. Accordingly, configurations disclosed herein perform a method of eliminating outliers by employing the value of a curvature and change in curvature to identify outliers. Such a curvature and change in curvature exaggerates exceptional irregularities. Conversion of the curvature to a discrete value may be employed to identify when the curvature exceeds a threshold indicative of an outlier (outlying value) or doubtful measurement.

In a particular configuration, a method of reading a sensor device as disclosed herein includes receiving a series of values from a sensor element of measurement equipment adapted to quantify an input stimuli into a value, and computing at least three consecutive curvatures from the received series of values. An aggregate value (sum) of the consecutive curvatures is compared to a threshold, and based on the comparison, the approach determines if the consecutive curvatures correspond to an outlier. The set of values are based on a signal that is continuous, although not necessarily differentiable, as received from the measurement equipment. Such measurement equipment embodying the sensor device may further comprise of atomic probe microscopes, interferometric microscopes, confocal microscopes, scanning laser microscopes, profiling instruments, scanners, and CMMs.

The equipment may be almost any kind of measurement equipment that produces a signal that should be continuous although not necessarily differentiable that could contain outliers (i.e., “doubtful observations”, unrealistic spikes in the data stream that comprises the signal). For example, this includes instruments used for measuring the topography of all kinds of surfaces at all scales, including atomic probe microscopes, interferometric microscopes, confocal microscopes, scanning laser microscopes, profiling instruments, scanners, CMMs (Coordinate Measuring Machines), computer tomography (CT), aerial terrain mapping (planes to satellites, earth and planets), and apparatus for ocean floor mapping.

The disclosed approach may also be used to find unusual behavior, or activity, that could be indicative of deviant trends or occurences, and has value in law enforcement, fraud, defense and terrorism, by incorporating a value gathering including a mechanism for representing these activities as a data stream in one or more dimensions.

A system employing the disclosed approach performs a method of reading a sensor device by receiving a series of values from a sensor element adapted to quantify an input stimuli into a value, and computing at least three consecutive curvatures from the received series of values. Typically, a sequence of curvatures would be gathered. An aggregate value of the consecutive curvatures is compared to a threshold; based on the comparison. It can be concluded that at least one of the consecutive curvatures corresponds to an outlier. In particular configurations, the set of values in the input stream or sequence are based on a signal that is continuous and not differentiable.

The sensor device may include any suitable surface or geographical analysis, including atomic probe microscopes, interferometric microscopes, confocal microscopes, scanning laser microscopes, profiling instruments, scanners, and CMMs. The expected series of values define a height over a two-dimensional area, and the comparison identifies an inaccurate height value. Such a comparison may further include evaluating successive degrees of derivatives based on the computed curvature, and identifying when the evaluated derivatives designate a set of values denoting an unattainable reading of height. Subsequent analysis determines if the designated set of values are outliers representative of invalid heights. Successive treatment includes filtering such as removing the group of outliers from an output set depicting a topography of a surface based on the height.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context view of outlier values in a topographical representation;

FIGS. 2A and 2B show graphs depicting outlier values based on curvature;

FIG. 3. shows a result of a correlation of measurements of a topological graph having outliers;

FIG. 4 shows a graph of a curvature derived from a topography as in FIG. 3;

FIG. 5A-5D show successive derivatives on a curvature value graph;

FIG. 6 shows a curvature derived from on spatial finite differences as a delta value;

FIG. 7 shows a graphical representation of the derived curvature of FIG. 6;

FIG. 8 shows a surface amenable to a topographical surface scan;

FIG. 9 shows a partially sintered particle in topography analysis;

FIG. 10 shows a rendering of surface data having outlier flaws;

FIG. 11 shows a rendering of the surface data of FIG. 10 adjusted for the outlier flaws; and

FIGS. 12A-12B show a flowchart of a particular configuration for computing outlier values.

### DETAILED DESCRIPTION

Configurations below depict an example implementation of the outlier filter used for measuring heights and aberrations of a surface. Conventional approaches, which rely on statistics, means and variance, applied to the individual values are becoming obsolete. Newer methods include thresholds in slope at one scale. Such conventional approaches require a datum to identify outliers and can falsely identify a cliff, i.e., the edge of a plateau, as an outlier. Frequency filters are also used to address outliers. Such filters have a tendency to eliminate legitimate data. Frequency filters only diminish the suspected outliers, rather than removing them.

Some prior art approaches employ heights and slopes to detect outliers. These have the disadvantage of having values which are dependent on a datum, meaning that the results rely on the orientation of the input surface. The value of the curvature is independent of the datum. Thus, the results should be repeatable regardless of the surface's orientation.

Additionally, conventional algorithms have a tendency to remove legitimate data while leaving points that should have been removed. This could be a result of using nonspecific metrics for outlier identification. In contrast, the proposed approach has the capability to be more specific in its identification of outliers, leading to improved accuracy and more complete removal of illegitimate data.

The demarcation between legitimate and outlying measurements or observations can be somewhat arbitrary. There are techniques for selecting a cut-off in heights, for example, to distinguish the outliers from the others. A desirable, although not required, result of the curvature and scale space characterization of the measurement is to have an extreme group in a bimodal distribution that clearly separates the outliers.

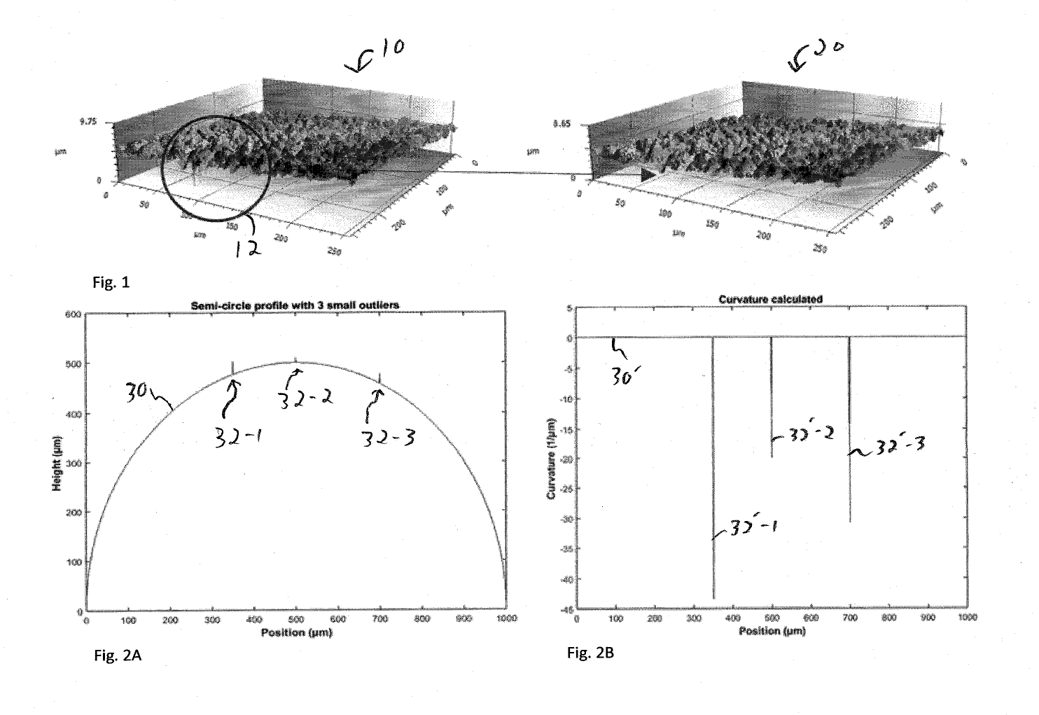

FIG. 1 is a context view of outlier values in a topographical representation. A topographical representation, or rendering, assigns a height to a grid arrangement of locations, and may be used for rendering such as machined surfaces or geological regions (i.e. maps). An initial geological data set presents a perspective view 10 of a 3D (3 dimensional) rendering. A segment of spurious values 12 is identifiable because they appear below ground. Following filtering for spurious values, a view 20 based on a corrected data set results. While visibly deviant, the spurious values 12 would pass unchecked to subsequent analysis techniques had the 3D rendering not made them apparent.

FIGS. 2A and 2B show graphs depicting outlier values based on curvature. Referring to FIGS. 2A and 2B, a graph 30 presents a profile of a semicircular object scan. Several peaks 32-1 . . . 32-3 (32, generally) show deviations from the otherwise smooth profile. In FIG. 2B, a graph of the curvature 30′ depicts peaks 32′-1 . . . 32′-3 (32′ generally). It can be visually observed that the curvature values in FIG. 2B amplify or accentuate the spurious values embodied as peaks 32 in the initial profile graph 30.

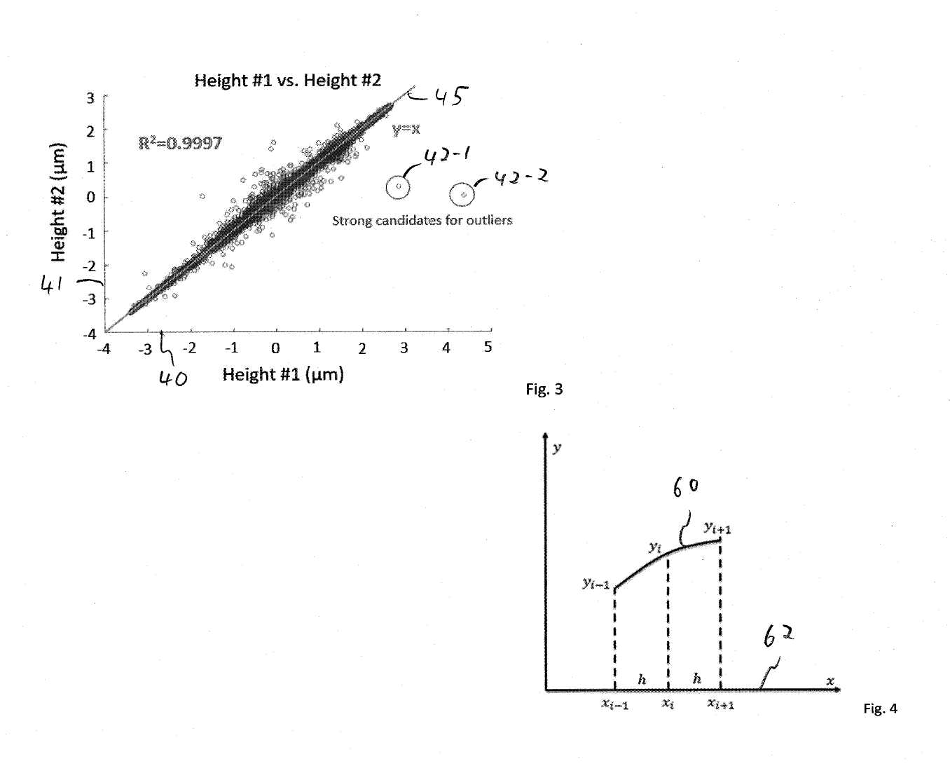

FIG. 3. shows a result of a correlation of measurements of a topological graph having outliers. Referring to FIGS. 2A-3, axes 40 and 41 designate height values for first and second data sets depicting height. Agreement between corresponding values would place a point on the diagonal line 45, indicating complete agreement between the two sets of height measurements. As can be seen, most of the values are clustered close to the diagonal line 45, however values 42-1 and 42-2 depict spurious values, substantially outlying the remaining data points, and are strong candidates to dismiss as inaccurate.

FIG. 4 shows a graph of a curvature derived from a topography as in FIG. 3. Curvature employs 3 points; in a Cartesian grid representation of height, which lends itself well to topographical renderings. Consecutive heights y[i−1], y[i] and y[i+1], shown by line 60, correspond to adjacent samples at x[i−1], x and x[i+1] on axis 62 . . . Spatial finite difference values are calculated using central differences:

$${y}^{′} = \frac{f ( x + h , y ) - f ( x - h , y )}{2 h}$$

$${y}^{″} = \frac{f ( x + h , y ) - 2 f ( x , y ) + f ( x - h , y )}{{h}^{2}}$$

Or alternatively,

$${y}_{i}^{′} = \frac{{y}_{i + 1} - {y}_{i - 1}}{2 h}$$

$${y}_{i}^{″} = \frac{{y}_{i + 1}^{′} - {y}_{i - 1}^{′}}{2 h}$$

$${{y}^{′}}_{i}^{″} = \frac{{y}_{i + 1}^{″} - {y}_{i - 1}^{″}}{2 h}$$

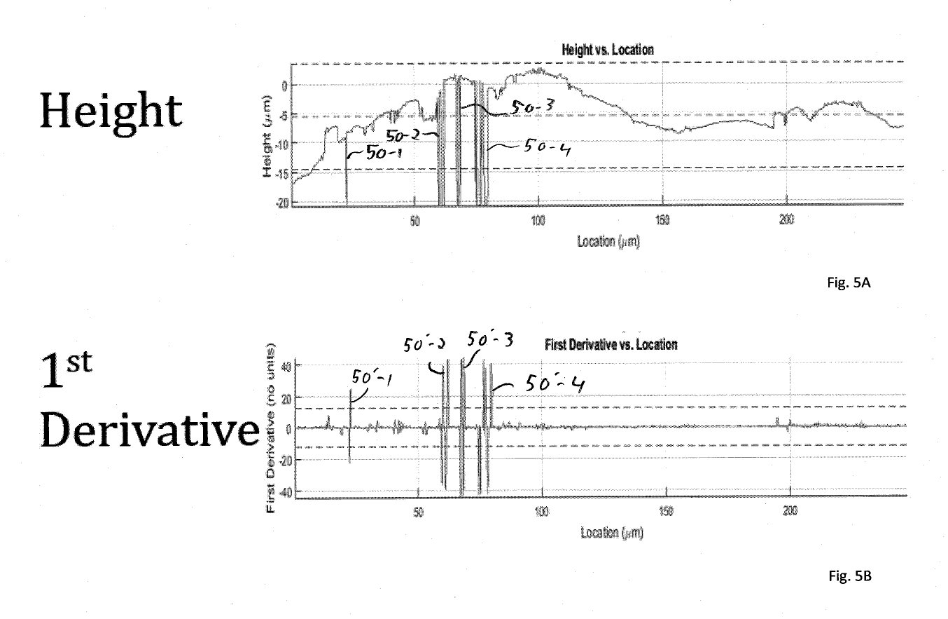

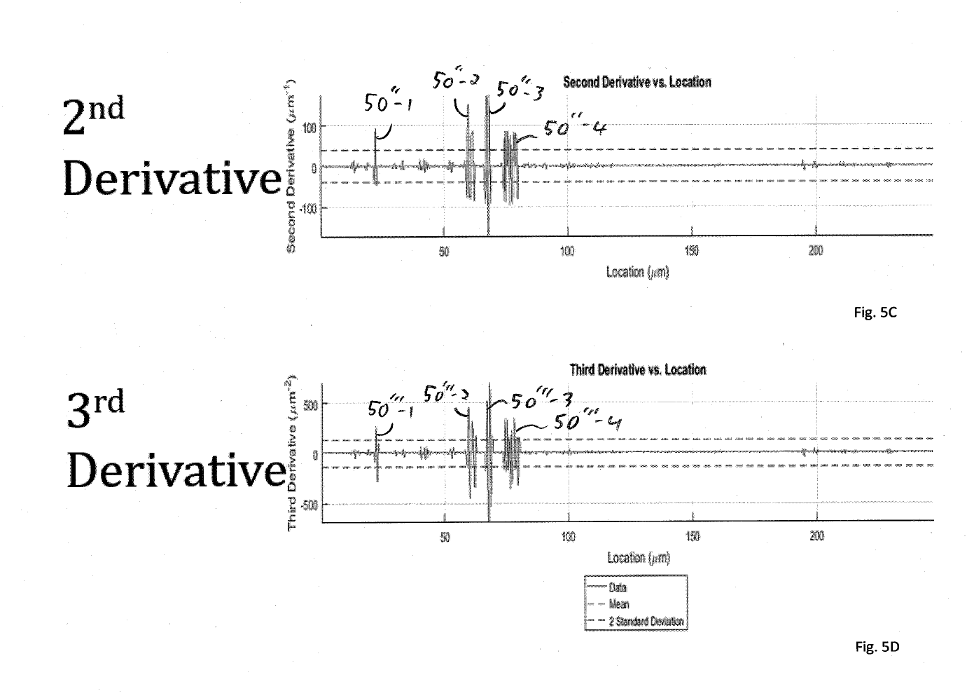

FIG. 5A-5D show successive derivatives on a curvature value graph. Referring to FIGS. 4 and 5A-5D, an outlier filter based on spatial finite differences such as curvature (2nd spatial finite difference) and higher, and at different scales, is effective at identifying outliers. FIG. 5A shows four distinct downward peaks, or “spikes” 50-1 . . . 50-4. In FIG. 5B, the first derivative, indicative of slope, shows upward and downward peaks 50′-1 . . . 50-4 corresponding to the spikes 50-1 . . . 50-4, showing the sharp upward and downward slopes. Upon taking successive derivatives based on curvature, 50″-1 . . . 50″-4 and 50′″-1 . . . 50′″-4, these anomalies remain amplified while other regions tend to diminish.

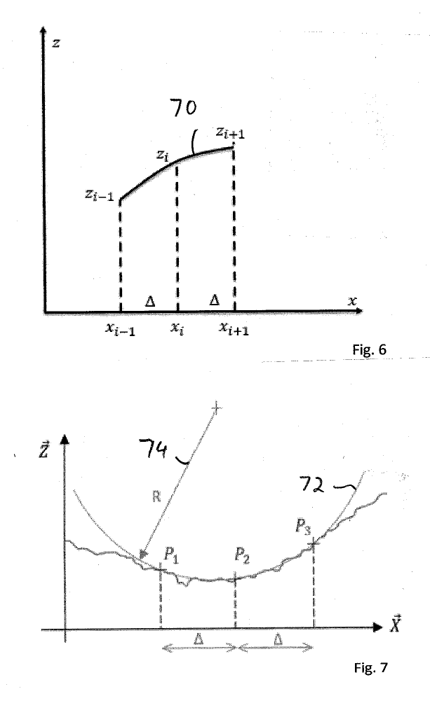

FIG. 6 shows a curvature derived from on spatial finite differences as a delta value. Referring to FIG. 6, the spatial finite differences are computed as follows, based on the curvature of line 70:

$${z}_{i}^{′} = \frac{{z}_{i + 1} - {z}_{i - 1}}{2 Δ}$$

$${z}_{i}^{″} = \frac{{z}_{i + 1}^{′} - {z}_{i - 1}^{′}}{2 Δ}$$

$${{z}^{′}}_{i}^{″} = \frac{{z}_{i + 1}^{″} - {z}_{i - 1}^{″}}{2 Δ}$$

FIG. 7 shows a graphical representation of the derived curvature of FIG. 6, computed as follows using an inverse k of a radius R 74 taken along 72:

$$k = 1 / R = \frac{{z}^{″}}{{( 1 + {z}^{′2} )}^{3 / 2}}$$

$${z}_{2}^{′} = \frac{{z}_{2} - {z}_{1}}{2 Δ}$$

$${z}_{2}^{″} = \frac{{z}_{3} - 2 {z}_{2} + {z}_{1}}{{Δ}^{2}}$$

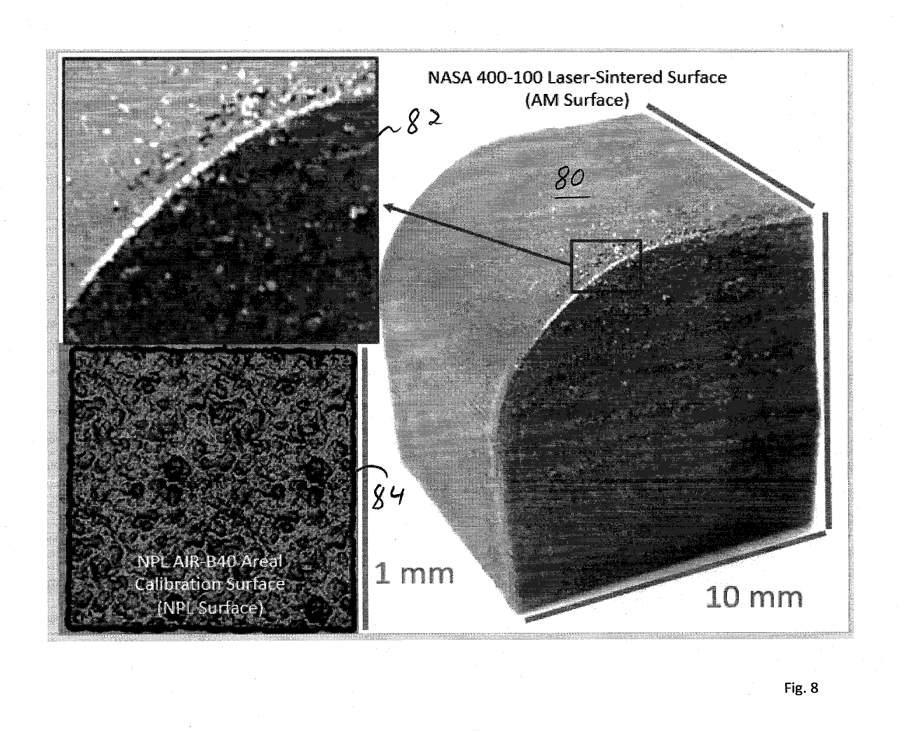

FIG. 8 shows a surface amenable to a topographical surface scan. Referring to FIG. 8, topographical scans are beneficial in surface analysis of machined surfaces 80. Magnified region 82 shows surface aberrations and a calibration surface 84 resulting from the surface 80.

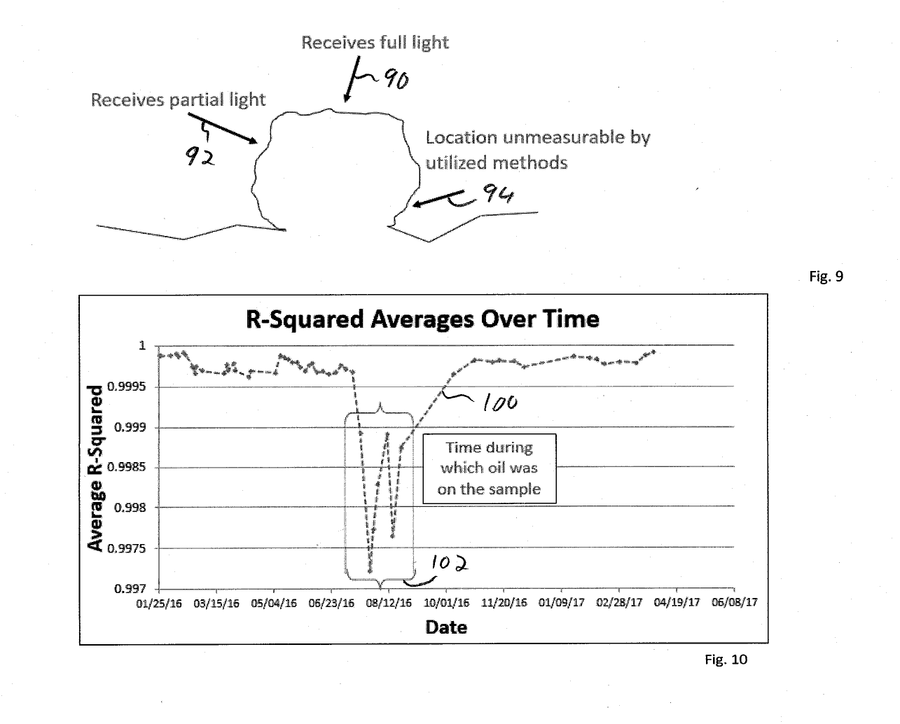

FIG. 9 shows a partially sintered particle in topography analysis. Referring to FIGS. 8 and 9, in a fabricated surface responsive to machining, such as in FIG. 8, partially sintered particles 90 exhibit a slope 92 that goes beyond vertical. In an example rendering using incident light falling on a surface, a sintered particle 90 would exert a steep slope 92 on a region receiving partial light. A reverse slope 94 is observed in an overhanging region that receives no incident light. Curvature measurements in regions such as 94 can be detected because the slope crosses vertical and may require discontinuous functions to interpret.

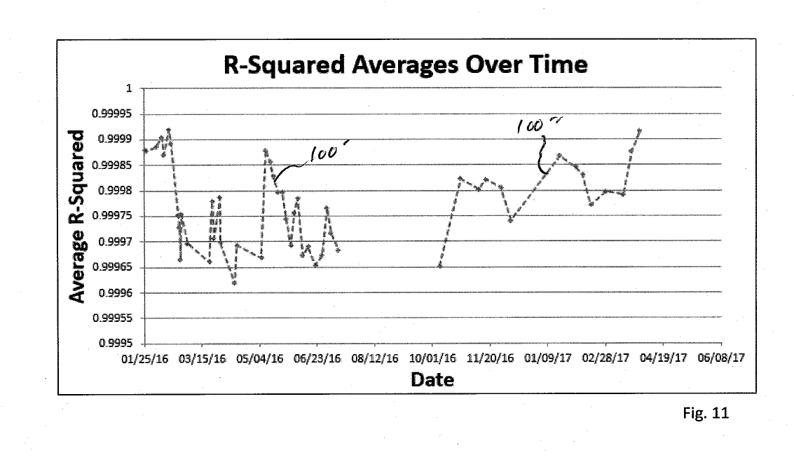

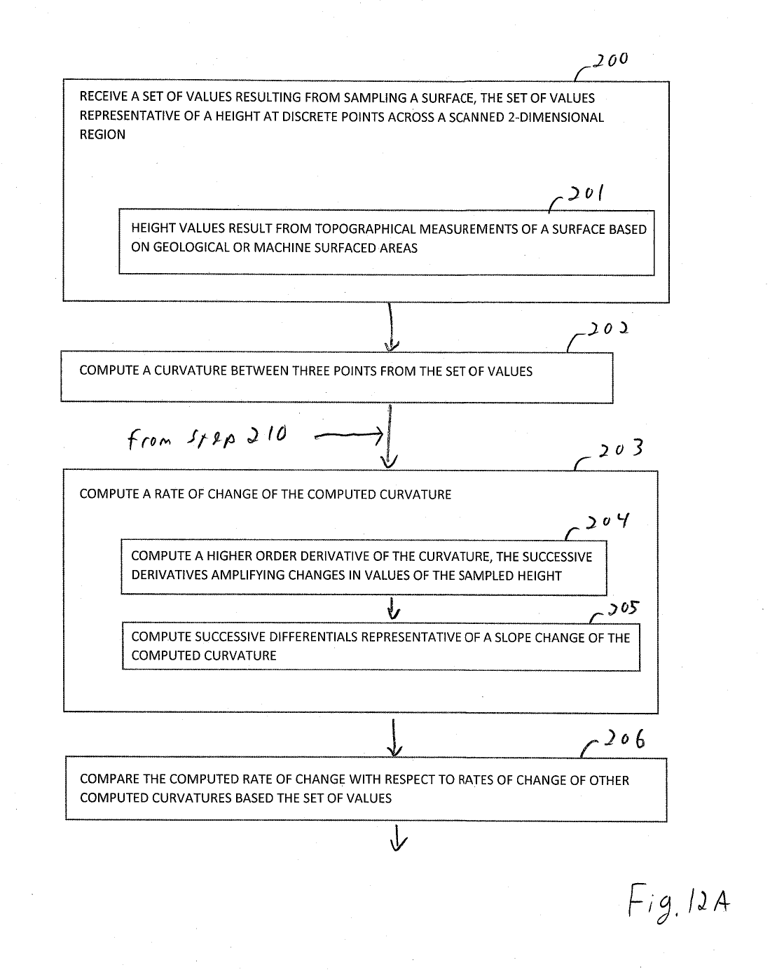

FIG. 10 shows a rendering of surface data having outlier flaws, and FIG. 11 shows a rendering of the surface data of FIG. 10 adjusted for the outlier flaws. Referring to FIGS. 10 and 11. In FIG. 10, a line 100 representative of repeatability exhibits several outliers in region 102, taken during a time at which oil was present on the surface and skewed the sensed measurements. FIG. 11 shows the line with the outlier portion removed, leaving bifurcated portions 100′ and 100″. In such a case, the data can be supplemented or accommodated by removing the outlier region 102.

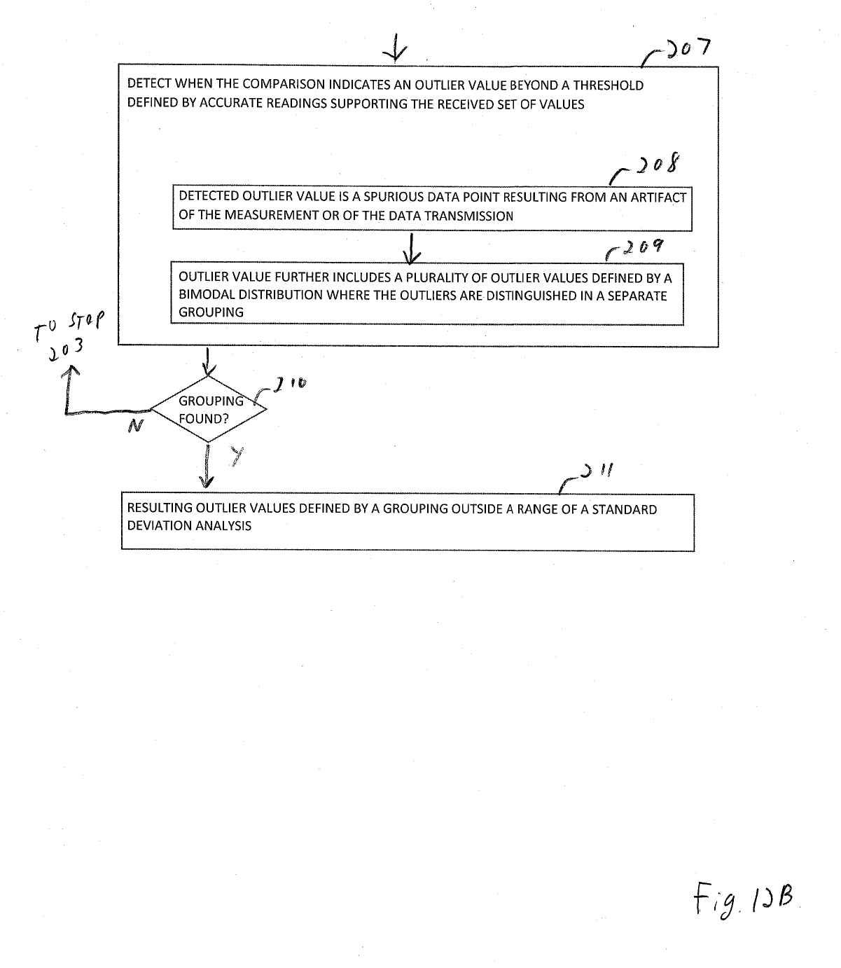

FIGS. 12A-12B show a flowchart of a particular configuration for computing outlier values. Referring to FIGS. 12A and 12B, the disclosed method of identifying invalid values in a topographical surface rendering includes, at step 200, receiving a set of values resulting from sampling a surface, the set of values representative of a height at discrete points across a scanned 2-dimensional region. In the example arrangement, the height values result from topographical measurements of a surface based on geological or machine surfaced areas, as shown at step 201. Topography data is common for both geographical data and for surface analysis of machined and fabricated surfaces having frictional, reflective, smoothness and other properties. From the sampled height values, a curvature is computed between three points from the set of values, as depicted at step 202, and a rate of change determined from the computed curvature, as shown at step 203. Typically, a large stream of values is employed and a series of computations for groups of 3 points analyzed to develop a curvature line or function. Computing the rate of change may include computing a higher order derivative of the curvature, such that the successive derivatives amplify changes in values of the sampled height, as depicted at step 204. This may progress or iterate for computing the rate of change further comprises computing successive differentials representative of a slope change of the computed curvature, as depicted at step 205. As emphasized above, successive derivatives tend to distinguish the outlier values such that a grouping emerges.

The successively differentiated curvature values are used for comparing the computed rate of change with respect to rates of change of other computed curvatures based the set of values to identify values which do not agree with other, more accurate or reasonable, values, depicted at step 206. After a number of iterations, the successively differentiated curvature can be used for detecting when the comparison indicates an outlier value beyond a threshold defined by accurate readings supporting the received set of values, as shown at step 207, typically distinguishing a group of values and also separating plateaus of legitimate values, which can often elude conventional outlier detection due to the steep slope leading to such a plateau. The true detected outlier value is a spurious data point resulting from an artifact of the measurement or of the data transmission, as disclosed at step 208. The outlier value may include a plurality of outlier values defined by a bimodal distribution where the outliers are distinguished in a separate grouping, as depicted at step 209, emphasizing a group and threshold setting apart the outliers from legitimate values.

A check is performed, at step 210, to determine if a grouping of outliers has emerged, and if not, control reverts to step 203 for successive differentiation. The resulting outlier values are defined by a grouping outside a range of a standard deviation analysis, as shown at step 211, as conventional standard deviation relies on an arbitrary threshold related to an arithmetic average, and can be eluded by plateaus or values not marked by an uncharacteristic slope. Conventional approaches and filters which merely attenuate, rather than eliminate outlier values, tend to simply “pull” the spurious values within the range of standard deviation analysis, thus the spurious data still exists in an attenuated form. In contrast, the claimed approach is particularly illuminating with group of outliers defining a plateau of values, and responding by increasing a sampling distance between the points defining the curvature measurement, modifying a granularity of the sampling. This has the effect of removing a subset of values in the plateau based on the increased sampling distance.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of reading a sensor device, comprising:
receiving a series of values from a sensor element adapted to quantify an input stimuli into a value;
computing at least three consecutive curvatures from the received series of values;
comparing an aggregate value of the consecutive curvatures to a threshold; and
based on the comparison, concluding that at least one of the consecutive curvatures corresponds to an outlier.

2. The method of claim 1 wherein the set of values are based on a signal that is continuous and not differentiable.

3. The method of claim 2 wherein the sensor device further comprises at least one of atomic probe microscopes, interferometric microscopes, confocal microscopes, scanning laser microscopes, profiling instruments, scanners, and CMMs.

4. The method of claim 1 wherein the series of values define a height over a two dimensional area, and the comparison identifies an inaccurate height value.

5. The method of claim 4 wherein the comparison further comprises:
evaluating successive degrees of derivatives based on the computed curvature;
identifying when the evaluated derivatives designate a set of values denoting an unattainable reading of height; and
determining the designated set of values as outliers representative of invalid heights.

6. The method of claim 5 further comprising removing the group of outliers from an output set depicting a topography of a surface based on the height.

7. A method of identifying invalid values in a topographical surface rendering, comprising:
receiving a set of values resulting from sampling a surface, the set of values representative of a height at discrete points across a scanned 2-dimensional region;
computing a curvature between three points from the set of values;
computing a rate of change of the computed curvature;
comparing the computed rate of change with respect to rates of change of other computed curvatures based the set of values;
detecting when the comparison indicates an outlier value beyond a threshold defined by accurate readings supporting the received set of values.

8. The method of claim 7 wherein computing the rate of change further comprises computing a higher order derivative of the curvature, the successive derivatives amplifying changes in values of the sampled height.

9. The method of claim 7 wherein the detected outlier value is a spurious data point resulting from an artifact of the measurement or of the data transmission.

10. The method of claim 7 further comprising computing the rate of change further comprises computing successive differentials representative of a slope change of the computed curvature.

11. The method of claim 10 wherein the outlier value further includes a plurality of outlier values defined by a bimodal distribution where the outliers are distinguished in a separate grouping.

12. The method of claim 11 wherein the height values result from topographical measurements of a surface based on geological or machine surfaced areas.

13. The method of claim 11 wherein the outlier values are defined by a grouping outside a range of a standard deviation analysis.

14. The method of claim 13 wherein the group of outliers define a plateau of values, further comprising:
increasing a sampling distance between the points defining the curvature measurement; and
removing a subset of values in the plateau based on the increased sampling distance.

15. A topographical measurement device for identifying invalid values in a topographical surface rendering, comprising:
an interface to a surface sensor for receiving a data set including a set of values resulting from sampling a surface, the set of values representative of a height at discrete points across a scanned 2-dimensional region;
analysis logic for computing a curvature between three points from the set of values and computing a rate of change of the computed curvature; and
a graphical rendering interface configured to compare the computed rate of change with respect to rates of change of other computed curvatures based the set of values, and detecting when the comparison indicates an outlier value beyond a threshold defined by accurate readings supporting the received set of values, the graphical rendering interface adapted to render an indication of the outlier value relative to accurate values.

16. The device of claim 15 wherein the analysis logic is configured to compute a higher order derivative of the curvature, the successive derivatives amplifying changes in values of the sampled height.

17. The device of claim 15 wherein the rendering interface is operable to compute the rate of change further by computing successive differentials representative of a slope change of the computed curvature.

18. The device of claim 17 wherein the outlier value further includes a plurality of outlier values defined by a bimodal distribution where the outliers are distinguished in a separate grouping.

19. The device of claim 15 wherein the surface sensor is responsive to height values resulting from topographical measurements of a surface based on geological or machine surfaced areas.

20. The device of claim 15 wherein the outlier further comprises a group of outliers defining a plateau of values, the analysis logic further configured to:
increase a sampling distance between the points defining the curvature measurement; and
remove a subset of values in the plateau based on the increased sampling distance.
